(19) United States
(12) Patent Application Publication
(10) Pub. No.: US 2004/0153659 A1
(43) Pub. Date: Aug. 5, 2004

(54) Identification module provided with a secure authentication code

(76) Inventors: David Naccache, Paris (FR); Pascal Paillier, Paris (FR); Helena Handschuh, Issy Les Moulineaux (FR); Christophe Tymen, Paris (FR)

Correspondence Address: BURNS DOANE SWECKER & MATHIS L L P, POST OFFICE BOX 1404, ALEXANDRIA, VA, 22313-1404, US

(21) Appl. No.: 10/467,928

(22) PCT Filed: Feb. 15, 2002
(86) PCT No.: PCT/FR02/00583

(30) Foreign Application Priority Data
Feb. 15, 2001 (FR) 01/02193

(51) Int. Cl. G06F 12/14

(52) U.S. Cl. 713/193

(57) ABSTRACT

The invention relates to an identification module comprising an authentication code in a permanent memory, said authentication code resulting from the application of a conversion to secret code function. The module also comprises means for generating said secret code. The invention also relates to a securement method which comprises the steps necessary for the abovementioned identification module to operate.

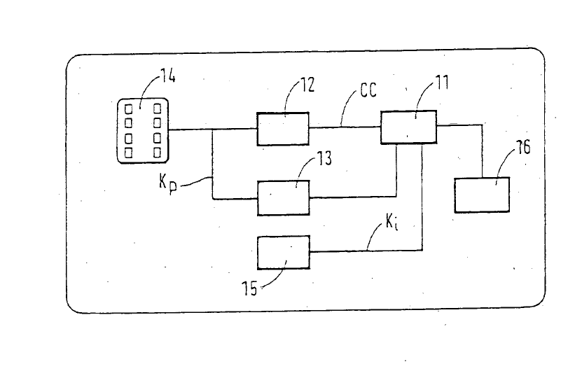

The present invention concerns an identification module comprising an identification code whose confidentiality is reinforced.

An identification module enables a subscriber to a service to identify himself to the operator of this service. This requires the connection of the module to a terminal of the network of the operator. The services concerned are of the most diverse and banking services and telephony services spring to mind first. By way of example, the mobile radio communication system complying with the GSM standard provides an identification module which is in the form of a card incorporating an electronic microcircuit, this card being connected in the mobile telephone of the subscriber.

The security of the service is provided by means of at least one authentication code recorded in the identification module. The authentication code which represents the identity of the subscriber is a secret data item which only the module and the operator should know, so that a third party cannot borrow the identity of the subscriber in order to benefit from the service fraudulently. The code can also be used to encrypt the message or the communication passing over the network of the operator in order to ensure confidentiality thereof. The field of cryptography is here assumed to be known. However, the work “Applied Cryptography”, Bruce Schneier, International Thomson Publishing France, which discloses the essentials of the knowledge necessary for implementing the present invention, is incorporated here by reference.

It is therefore clear that the secret character of the authentication code assumes the highest importance.

Current technology guarantees inviolability of the identification module so that it is considered that the authentication code is inaccessible as soon as it is recorded in the module. However, this code may undergo various attacks following its creation by a random number generator, during its transmission to the operator, or when it is transferred into the identification module.

It has therefore been envisaged enciphering the code immediately after its creation and then transmitting it to the module enciphered. It is then necessary to transmit the deciphering key to the module so that it can recover the original code. Naturally, the deciphering key exhibits the same vulnerability as the authentication code when it is transmitted without having been enciphered.

Thus the recovery of the authentication code requires an additional step, but is not impossible.

The first object of the present invention is therefore to reinforce the protection of the authentication code.

According to the invention, an identification module comprises an authentication code in a permanent memory, this authentication code resulting from the application of a secret code conversion function; the module also comprises means for generating this secret code:

The identification module therefore has available the authentication code which benefits from the greatest confidentiality since it has been produced locally.

It is now necessary to communicate this code to the operator whilst preserving its secret nature. To do this a public-key cryptosystem is provided. The identification module enciphers the code with the public key of the operator before transmitting it to him. The operator recovers the authentication code using his secret key. The weak point which appears here is a possible substitution for the public key. This is because a third party could communicate a key to the identification module which is compatible with the cryptosystem in order to recover the authentication code.

A second object of the invention is to combat the usurping of the capacity of operator by means of the public key.

The solution consists of providing in the module encrypting means for producing an encrypted code by enciphering the authentication code by means of a public key, transmission means for communicating this encrypted code, the activation of these transmission means being dependent on the prior acquisition of an immutable public code.

Since the module knows one public code and only one, an undifferentiated communication of the authentication code to two correspondents which request it successively is thus prevented.

According to a first embodiment of the invention, the module comprises means for receiving a certificate for the public key and means for deciphering this certificate with the public code.

The use of a certification authority guarantees that the public key belongs to the operator by means of the certificate.

Alternatively, the public code being merged with the public key, the module comprises means for implementing the conversion function by combining the public key and the secret code.

It is thus possible to easily detect a communication of the authentication code with another public key.

According to a second embodiment, the module comprises an inalterable memory in which the authentication code is recorded.

Advantageously, the authentication code is an assembly of the public key and the secret code.

According to a variant, the authentication code results from a function of hashing the public key and the secret code.

According to another variant, the authentication code has an initial value which results from a function of hashing the public key and the secret code, this initial value then being replaced by the secret code.

According to yet another variant, the authentication code results from an exponentiation of the public key by means of the secret code modulo n.

The invention also concerns a protection method which comprises the steps necessary for making the above authentication module function.

The present invention will appear now with more details in the context of the description which follows of example embodiments given by way of illustration with reference to the accompanying single FIGURE which depicts a diagram of an identification module.

The identification module is often in the form of a card comprising an electronic microcircuit. This is the case in particular in the GSM radiotelephony system, where it is referred to as a “SIM card” corresponding to the English term “Subscriber Identification Module Card”.

With reference to the FIGURE, the module comprises a microcontroller 11 connected firstly to transmission means 12 and secondly to acquisition means 13. These transmission means and acquisition means are also connected to a connector 14 provided for connection to a terminal. The module also comprises a random number generator 15 connected to the microcontroller 11, it being understood that this generator could be integrated in this microcontroller. It also comprises a non-erasable memory 16 in which it is possible to write once and read as many times as necessary. The content of this memory cannot therefore be modified. In practice, a “EEPROM” (standing for the English expression “Electrically Erasable Programmable Read Only Memory”) component or a “WORM” (standing for the English expression “Write Once Read Many”) component is envisaged. The interaction of the various elements of the identification module will emerge during the following description. However, as of now, it should be stated that the generator 13 is devoted to the production of a secret code Ki.

The authentication code produced from the secret code Ki is submitted to encrypting means which, ideally, are integrated in the microcontroller 11. The encrypting means use a public-key enciphering algorithm such as “RSA” (from the name of its authors Ron Rivest, Adi Shamir and Leonard Adleman), El Gamal (also from the name of its author) or any other available algorithm. They produce an encrypted code CC by enciphering the secret code Ki by means of the public key Kp acquired via the acquisition means 13. The encrypted code CC is then supplied to the transmission means 12.

According to a first embodiment of the invention, the operator belongs to a consortium which has chosen a certification authority. The operator requests from this authority a certificate for his public key. The certificate, which contains the public key and the identity of the operator, is signed by the certification authority. The signature algorithm can also be of the “RSA” or “DSA” (standing for the English expression “Digital Signature Algorithm”) type. The verification key Kv which makes it possible to verify the certificate is public by its very essence; it is a public code. This key Kv is recorded permanently in the identification module, for example in the memory 16. It can even be directly etched in the module microcircuit.

When the module is requested to supply its secret code Ki, it acquires the public key Kp from the operator by virtue of the acquisition means 13. In the present case, the conversion function is reduced to the identity function and, consequently, the authentication code is identical to the secret code. Next the module requests the certificate, which it decrypts by means of the verification key Kv. If the certificate is not in conformity, the module blocks transmission of the secret code Ki. The invention can also be implemented without using a certification authority.

For example, when the identification module receives a public key for the first time, the original key Ko, it records it definitively in the non-erasable memory 16.

This original key Ko can here also be considered to be a public code.

According to a first option, when the module once again receives a public key, if the latter differs from the original key Ko, it goes into fault mode and refuses all other operations.

According to a second option, when the module acquires a new public key, it ignores it, using the original key Ko for all the operations requiring the use of the public key Kp of the operator. The latter will not fail to detect any anomaly since the data transmitted to it by the module are enciphered with the original key Ko, which differs from its public key Kp.

According to another embodiment, the identification module still receives an original key Ko before transmitting its enciphered authentication code Ca. The term public key must be understood in its extended sense, that is to say it comprises all the public data necessary for enciphering. Thus, in the case of the “RSA” algorithm, these data comprise the key proper, that is to say the exponent, and the modulo according to which the enciphering operation is performed.

The module fulfils a conversion function which is here a function H(Ki, Ko) of hashing the secret code Ki and the original key Ko. For the record, a single-direction hash function is easy to calculate; knowing the result, it is difficult to find the value which gives this result; it is difficult to find two values which lead to the same result. By way of example the standardised “SHA” (standing for the English expression “Secure Hash Algorithm”) can-be cited.

The result of this hash function constitutes the authentication code Ca=H(Ki, Ko) which is recorded in the non-erasable memory 16. The module transmits the secret code Ki to the operator, who calculates his own authentication code Co=H(Ki, Kp) by means of his public key Kp. If the original key Ko and the public key differ, there is a mismatch between the authentication code Ca calculated by the module and the one Co calculated by the operator, so that the module cannot function.

According to a variant, the identification module still receives the original key Ko. It records the secret code key Ki and this original key Ko in the memory 16, the conversion function now consisting of effecting the assembly or concatenation of the two data constituting its authentication code Ca.

The module sends the secret code Ki to the operator, who produces his own authentication code Co by assembling the secret code Ki and his public key Kp in the same way as the module has done. Here also, the authentication codes obtained by the module Ca and by the operator Co are different if the public key Kp of the operator does not correspond to the original key Ko.

According to another variant, the module produces, when first connected to the network of the operator, an authentication code Ca which is equal to a function of hashing the secret code and the original key H(Ki, Ko) As mentioned before, the operator then calculates his own authentication code Co=H(Ki, Kp) by means of his public key. In the event of any difference between the two authentication codes Ca, Co, the operator invalidates the identification module. On the other hand, if the original key Ko and his public key Kp correspond, it is possible now to use the secret code key Ki as an authentication code.

According to another embodiment, the invention uses an algorithm of the “Diffie-Hellman” type (from the name of its authors). This therefore involves a commutative field such as a basic field or a field formed by means of an elliptic curve. The public key Kp of the operator is here formed from a first data item g and a second data item L=g^{x} mod n, where x represents the secret key of the operator, the expression mod n signifying that the operation is performed modulo n. This public key is communicated to the identification module, which calculates a third data item M=L^{Ki} mod n and a fourth data item N=g^{Ki} mod n where Ki still represents the secret code. The module then performs a function H(M, N) of hashing the third and fourth data items, which it records in the non-erasable memory 16. It sends the fourth data item N to the operator. The authentication code is in this case equal to the result of the hash function H(M, N)=H(g^{xKi}, g^{Ki}).

It should also be noted here that, if the module uses a first or second data item which does not correspond to the public key of the operator, the hash functions calculated by the module and by the operator would not be identical. The example embodiments of the invention presented above have been chosen for their concrete character. It would however not be possible to exhaustively list all the embodiments which cover this invention. In particular, any step or means described may be replaced by an equivalent step or means without departing from the scope of the present invention.

1. An identification module comprising an authentication code in a permanent memory, this authentication code resulting from the application of a secret code conversion function, characterised in that it comprises means (15) for generating this secret code (Ki).

2. A module according to claim 1, characterised in that, comprising encrypting means (11) for producing an encrypted code (CC) by enciphering the said authentication code by means of a public key (Kp), comprising transmission means (12) for communicating the said encrypted code (CC), the activation of the said transmission means (12) is dependent on the prior acquisition of an immutable public code (Kp, Kv).

3. A module according to claim 2, characterised in that, comprising means (13) for receiving a certificate for the said public key (Kp), it comprises means (11) for deciphering this certificate with the said public code (Kv).

4. A module according to claim 2, characterised in that, the said public code being merged with the said public key (Kp), it comprises means (11) for performing the said conversion function by combining the said public key (Kp) and the said secret code (Ki).

5. A module according to claim 2, characterised in that it comprises an unalterable memory (16) in which the said authentication code is recorded.

6. A module according to either one of claims 4 or 5, characterised in that the said authentication code is an assembly of the said public key (Kp) and the said secret code (Ki).

7. A module according to either one of claims 4 or 5, characterised in that the said authentication code results from a function of hashing the said public key (Kp) and the said secret code (Ki).

8. A module according to either one of claims 4 or 5, characterised in that the said authentication code has an initial value which results from a function of hashing the said public key (Kp) and the said secret code (Ki), this initial value then being replaced by the said secret code (Ki).

9. A module according to either one of claims 4 or 5, characterised in that the said authentication code results from an exponentiation of the said public key (Kp) by means of the said secret code (Ki) modulo n.

10. A method of protecting an identification module comprising an authentication code resulting from the application of a secret-code conversion function, characterised in that it comprises a step of generating the said secret code (Ki) within the said module.

11. A method according to claim 10, characterised in that it comprises a step for acquiring and recording a public code (Kp, Kv) in a non-rewritable memory (16).

12. A method according to claim 11, characterised in that, comprising a step of acquiring a public key (Kp), this public key being provided for the enciphering of the said authentication code, it comprises a step for acquiring an enciphered certification of the said public key (Kp), a step for deciphering this certification by means of the said public code (Kv) and a step for verifying the deciphered certification.

13. A method according to claim 11, characterised in that, the said public code being a public key (Kp) used in a step of encrypting the said authentication code, it comprises a step for performing the said conversion function by combining the said public key (Kp) and the said secret code (Ki).

14. A method according to claim 13, characterised in that the said authentication code is an assembly of the said public key (Kp) and the said secret code (Ki).

15. A method according to claim 13, characterised in that the said authentication code results from a function of hashing the said public key (Kp) and the said secret code (Ki).

16. A method according to claim 13, characterised in that, comprising a step of transmitting the said encrypted authentication code (CC), during the first execution of this step, the said authentication code results from a function of hashing the said public key (Kp) and the said secret code (Ki), whilst, during following executions of this same step, the said authentication code is equal to the said secret code (Ki).

17. A method according to claim 13, characterised in that the said authentication code results from an exponentiation of the said public key (Kp) by means of the said secret code (Ki) modulo n.
